(19) United States
(12) Patent Application Publication
(10) Pub. No.: US 2025/0015300 A1
(43) Pub. Date: Jan. 9, 2025

(54) METHOD OF PREPARING COATING INK COMPOSITION, AND LITHIUM SECONDARY BATTERY FOR THERMAL RUNAWAY DELAY INCLUDING ELECTRODE COATED WITH COATING INK PREPARED BY THE METHOD

(71) Applicant: KB-ELEMENT Co., Ltd., Paju-si (KR)

(72) Inventors: Kyoung Jeong BAE, Suwon-si (KR); Jung Tak SEO, Seoul (KR); Sul Hwa CHOI, Seongnam-si (KR); Seong Gwan SHIN, Goyang-si (KR); Soon Kyu Hong, Goyang-si, Gyeonggi-do (KR)

(73) Assignee: KB-ELEMENT Co., Ltd., Paju-si (KR)

(21) Appl. No.: 18/625,270

(22) Filed: Apr. 3, 2024

(30) Foreign Application Priority Data
Jul. 4, 2023 (KR) 10-2023-0086279

(51) Int. Cl. H01M 4/66; H01M 4/02; H01M 4/62; H01M 10/052

(52) U.S. Cl. CPC H01M 4/663; H01M 4/62; H01M 4/667; H01M 10/052; H01M 2004/021

(57) ABSTRACT

A lithium secondary battery for thermal runaway delay, includes an electrode coated with a coating ink prepared by the method The method of preparing a coating ink composition uses expandable graphite (EG) as a starting material to obtain non-oxidized graphene, so there is no reduction process, no acid is used, and through a simple manufacturing process, manufacturing costs and times can be reduced while enabling mass-production and causing no environmental problems. Further, the coating ink composition prepared by the method of preparing the coating ink composition can improve properties such as viscosity, dispersion stability, electrical conductivity, and substrate adhesion of the ink by using a polymer as an additive. In addition, by coating the electrode of the secondary battery with the coating ink composition containing graphene nanoplatelets or non-oxidized graphene, thermal runaway due to overload of thermal energy generated within the secondary battery can be delayed and prevented.

### CROSS REFERENCE TO RELATED APPLICATIONS

This application claims priority to Korean Patent Application No. 10-2023-0086279 filed on Jul. 4, 2023, which is hereby incorporated by reference in its entirety.

### BACKGROUND OF THE INVENTION

The present disclosure relates to a method of preparing a coating ink composition, and a lithium secondary battery for thermal runaway delay including an electrode coated with a coating ink prepared by the method.

In general, graphene is a two-dimensional allotrope made of carbon atoms and has a honeycomb-shaped hexagonal structure, and it has a material having a very large specific surface area relative to volume (about 2600 m²/g), theoretically excellent capacitor properties of 550 Fg⁻¹, and physical and chemical stability. Graphene has infinite application potential, as an energy storage material, a transparent electrode film, a barrier film, a graphene/metal composite, a heat dissipation material, etc.

Methods of preparing such graphene include graphene flake (GF), which is produced by exfoliating graphene from graphite crystals, and CVD (Chemical Vapor Deposition) grapheme, which is produced by chemical vapor deposition.

However, in the case of CVD graphene produced by chemical vapor deposition, it is produced by gasifying carbon at high temperature and depositing it on a metal surface, so it is possible to produce large-area, high-quality graphene, but it is difficult to mass-produce and it is not easy to proceed with the process for application to actual products.

On the other hand, graphene flakes can be mass-produced at low cost, but their performance is somewhat poor and their dispersibility is low, so there is a limit to the product range to which they can be applied.

Therefore, recently, the technology disclosed in Patent Document 1 has been proposed as a technology to solve the above problems.

Patent Document 1 discloses a graphene ink composition comprising chemically modified graphene, graphene flakes, a binder, and a solvent, and having an absolute value of zeta potential of the charged chemically modified graphene of 25 mV or more.

However, Patent Document 1 includes a process of exfoliating graphite oxide and chemically modifying the exfoliated graphene several times, and furthermore, the ink composition is prepared through a process of preparing a first colloid and a second colloid separately and then mixing the binder and solvent, which results in increased production cost and time, difficulties in mass production, and environmental pollution due to the use of chemicals such as acids and binders.

Meanwhile, Patent Document 2 discloses a secondary battery using a heat-absorbing additive that can increase the stability of the cell by absorbing heat when abnormal heat generation occurs in the secondary battery and prevent thermal runaway phenomenon caused by abnormal use.

However, in Patent Document 2, there is the inconvenience of having to assemble a swelling material containing an additional heat-absorbing additive to the electrode assembly to prevent or delay thermal runaway, which dissipates the heat energy generated within the secondary battery to the outside, so that thermal runaway occurring within the secondary cannot be substantially prevented.

Accordingly, in order to solve the above problems, there is a need for a method of preparing a coating ink composition in which an environmentally friendly non-oxidized graphene that does not cause environmental problems is prepared by using expandable graphite (EG) as a starting material to obtain since non-oxidized graphene without a reduction process and without the use of acids, and which makes it possible to mass-produce while reducing manufacturing cost and time through a simple manufacturing process.

In addition, there is a need for a method of preparing an ink composition capable of delaying and preventing thermal runaway due to overload of thermal energy generated within the secondary battery by coating the electrode of the secondary battery with a coating ink composition containing graphene nanoplatelets or non-oxidized graphene.

### PRIOR ART DOCUMENT

### Patent Document

Patent Document 1: Korean Patent Application Publication No. 10-2018-0086676 (published on Aug. 1, 2018)
Patent Document 2: Korean Patent Publication No. 10-2331161 (registered on Nov. 22, 2021)

### SUMMARY OF THE INVENTION

In view of the above, the present disclosure provides a method of preparing a coating ink composition, and a lithium secondary battery for thermal runaway delay including an electrode coated with a coating ink prepared by the method.

In order to solve the problems described above, the present disclosure provides a method of preparing a coating ink composition, the method comprising the steps of:
(a) preparing graphene nanoplatelets using thermal plasma;
(b) mixing and stirring a polymer in a solvent to prepare a first polymer solution;
(c) adding the prepared graphene nanoplatelets to the prepared first polymer solution to prepare a first graphene solution;
(d) homogenizing the first graphene solution at high speed to prepare a second graphene solution; and
(e) preparing a coating ink composition containing graphene nanoplatelets using the second graphene solution under shear stress in a high-pressure homogenizer.

Further, an average particle size of the graphene nanoplatelets may be 0.1 μm to 100 μm.

Further, the solvent may be at least one selected from the group consisting of water, alcohol solvents including ethanol, chloroform, glycerol, and acetic acid.

Further, the polymer may be at least one selected from the group consisting of polyvinylpyrrolidone (PVP), polyvinyl alcohol (PVA), polyethylene glycol (PEG), polypropylene glycol (PPG), polyacrylo nitrile (PAN), and polyacrylic acid (PAA).

Further, the first polymer solution may be a mixture of the solvent and the polymer at a mixing ratio of 95:5 or 5:1.

Further, the graphene nanoplatelets added to the first polymer solution in the step (c) may be added at a mixing ratio of 0.2 to 20 parts by weight based on 100 parts by weight of the first polymer solution.

The method of preparing a coating ink composition may further comprise: (f) preparing graphene nanoplatelets using thermal plasma; and (g) pulverizing the graphene nanoplatelets using an air jet mill to prepare non-oxidized graphene powder.

Further, an average particle size of the non-oxidized graphene powder may be 0.2 μm to 20 μm.

Further, the present disclosure provides a coating ink prepared by the method of preparing a coating ink composition described above.

Further, the present disclosure provides a method of coating a metal surface, which comprises: coating the above-described coating ink on a metal surface; and forming a graphene coating film on the metal surface by drying or heat-treating the coated coating ink.

Further, the coating of the coating ink may be performed by one selected from dip-coating, doctor-blade coating, slot-die coating, and spray coating.

Further, in the forming of the graphene coating film, the graphene coating film may be dried at a temperature of 30° C. to 100° C. for 5 to 30 minutes, or heat-treated at a temperature of 100° C. to 200° C. for 10 to 120 minutes.

Further, the present disclosure provides a graphene-coated metal material comprising: a metal material; and a graphene coating film coated on a surface of the metal material by the method of coating a metal surface described above.

Further, the present disclosure provides a lithium secondary battery comprising: an electrode having a surface of a current collector coated with the above-described coating ink.

Further, the coated electrode may be an anode and/or a cathode.

Further, the lithium secondary battery may be a lithium secondary battery for thermal runaway delay.

In the method of preparing a coating ink composition according to the present disclosure, by using expandable graphite (EG) as a starting material to obtain since non-oxidized graphene without a reduction process and without the use of acids, so that it is possible to mass-produce while reducing manufacturing cost and time through a simple manufacturing process and no environmental problem occurs.

Further, the coating ink composition prepared by the method of preparing the coating ink composition according to the present disclosure can improve properties such as viscosity, dispersion stability, electrical conductivity, and substrate adhesion of the ink by using a polymer as an additive.

In addition, the coating ink composition prepared by the method of preparing the coating ink composition according to the present disclosure can delay and prevent thermal runaway due to overload of thermal energy generated within the secondary battery by coating the coating ink composition containing graphene nanoplatelets or non-oxidized graphene on the electrode of the secondary battery.

### BRIEF DESCRIPTION OF THE DRAWINGS

The accompanying drawings are intended to explain the present disclosure in more detail to those of ordinary skill in the art, and the technical idea of the present disclosure is not limited thereto.

FIG. 1 is a flowchart illustrating a method of preparing a coating ink composition using graphene nanoplatelets according to one embodiment of the present disclosure.

FIG. 2 is a flow chart illustrating a method of preparing a coating ink composition using non-oxidized graphene powder according to one embodiment of the present disclosure.

FIG. 3 is an SEM image showing graphene nanoplatelets prepared by the method of preparing a coating ink composition according to one embodiment of the present disclosure.

FIG. 4 is an SEM image showing non-oxidized graphene prepared by the method of preparing a coating ink composition according to one embodiment of the present disclosure.

FIG. 5 is an image showing an ink composition prepared by the method of preparing a non-oxidized graphene ink composition for coating according to one embodiment of the present disclosure.

FIG. 6 is a graph showing the results of measuring the ink composition prepared by the method of preparing a coating ink composition according one an embodiment of the present disclosure using Turviscan.

FIG. 7 is a graph showing the results of comparing the ink compositions prepared by the method of preparing a coating ink composition according to one embodiment of the present disclosure using a Brookfield viscometer.

FIG. 8 is a graph showing the results of measuring the ink composition prepared by the method of preparing a coating ink composition according to one embodiment of the present disclosure using Turviscan.

### DETAILED DESCRIPTION OF THE INVENTION

Hereinafter, a method of preparing a non-oxidized graphene ink composition for coating according to the present disclosure will be described in detail. However, the scope of the method of preparing a non-oxidized graphene ink composition for coating is not limited by the following description.

Throughout the specification, when it is described that a part “includes or comprises” a certain component, this means that the part may further include other components rather than excluding other components, unless specifically stated to the contrary.

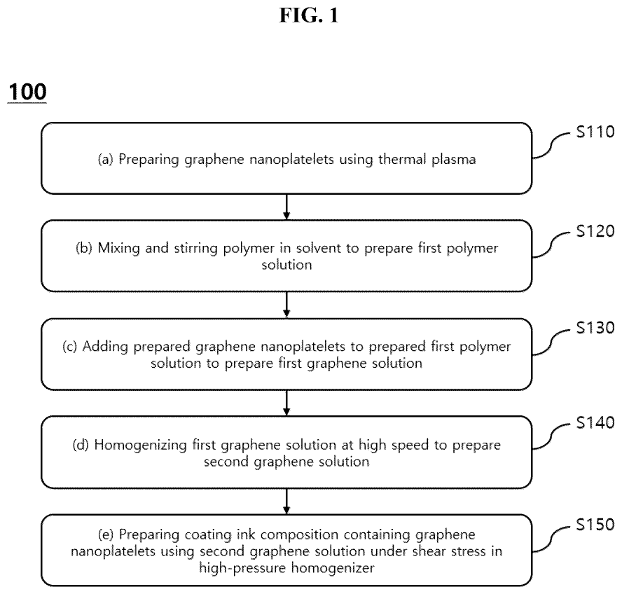

FIG. 1 is a flowchart illustrating a method 100 of preparing a coating ink composition using graphene nanoplatelets according to one embodiment of the present disclosure.

Referring to FIG. 1, the method 100 includes: (a) preparing graphene nanoplatelets using thermal plasma (S110); (b) mixing and stirring a polymer in a solvent to prepare a first polymer solution (S120); (c) adding the prepared graphene nanoplatelets to the prepared first polymer solution to prepare a first graphene solution (S130); (d) homogenizing the first graphene solution at high speed to prepare a second graphene solution (S140); and (e) preparing a coating ink composition containing graphene nanoplatelets using the second graphene solution under shear stress in a high-pressure homogenizer (S150).

Hereinafter, the method 100 of preparing a non-oxidized graphene coating ink composition according to one embodiment of the present disclosure will be described in detail.

### Preparation Example 1

Referring to FIGS. 1 and 3, in the step (a) S110 of preparing graphene nanoplatelets using thermal plasma, expandable graphite (EG) is introduced into a thermal plasma device, and expanded by thermal plasma treatment to exfoliate the graphene, thereby obtaining graphene nanoplatelets.

Here, the term “expandable graphite” in the present specification may mean a material in which graphite is chemically expanded by mixing the graphite with a sulfur or nitrogen compound. In this case, expandable graphite may also mean a material in which the sulfur or nitrogen compound is used as an interlayer interpenetrating material in the graphite, so that interlayer delamination of the graphite has occurred due to the interlayer penetration of the sulfur or nitrogen compound, and the material may be further physically expanded by applying energy.

Since detailed descriptions of expandable graphite (EG) are known in the art, detailed descriptions thereof will be omitted.

The present inventors found that when exfoliating graphene using a graphite material, oxidation of the surface of the graphite should be induced, but since the oxidation is mainly accomplished using strong acids, environmental problems arise, and found that when the oxidized graphite is used, since graphene should be reduced again after the graphene is produced to realize its properties, which requires additional process, so it is difficult to obtain high-purity graphene continuously and in large quantities.

Furthermore, in the case of exfoliating graphene from expanded graphite (EG) as described in the present disclosure, when graphene is exfoliated from graphite by applying the conventional electrochemical exfoliation method, non-oxidation exfoliation method, graphene oxide reduction method, and thermal expansion method, sp2 bonds between carbons in graphite are broken, resulting in a significant deterioration of properties such as strength, thermal conductivity, electron mobility, etc. of the graphite, and the graphite has to be discarded.

Accordingly, the present inventors have achieved the present disclosure by confirming that when using expandable graphite (EG) as described in the present disclosure, there is no environmental problem due to no use of strong acids, no additional reduction process is required, and the properties of expandable graphite (EG) do not change even after the graphene is exfoliated from the expandable graphite (EG), so that high-purity graphene that can be recycled and used commercially and continuously can be obtained.

Therefore, in the method 100 of preparing a coating ink composition according to one embodiment of the present disclosure, it is necessary to use expandable graphite (EG) as a starting material.

However, in the case of using expandable graphite (EG), considering that the volume of expandable graphite increases by more than 200 times when exfoliating graphene, it has been difficult to rapidly mass-produce graphene commercially because when expanding and exfoliating expandable graphite (EG) to exfoliate graphene using a high-temperature box-type furnace or tunnel-type furnace, only a few grams of graphene per hour can be obtained even if the volume of the furnace is large, and the powder needs to be collected separately after the reaction, which makes it difficult to perform continuous production.

Accordingly, the present inventors solved the above problem by using thermal plasma to continuously obtain high-purity graphene without the need for a separate additional process when obtaining graphene from the expandable graphite.

FIG. 3 is an SEM image showing graphene nanoplatelets prepared by the method of preparing a coating ink composition according to one embodiment of the present disclosure.

Referring to FIG. 3, an average particle size of the graphene nanoplatelets is 0.1 μm to 100 μm, preferably 0.2 μm to 70 μm, and more preferably 0.5 μm to 50 μm.

That is, graphene nanoplatelets continuously prepared from expandable graphite (EG) according to the present disclosure can be obtained in high purity with very few impurities without the need for a reduction process, and the resulting ink composition can also have excellent physical properties.

Then, in the step (b) S120, a first polymer solution is prepared by mixing and stirring a polymer in a solvent.

Here, as the solvent, a polar solvent, such as water, an alcohol solvent including ethanol, chloroform, glycerol, and acetic acid, may be used, and more specifically, one or more types selected from the group consisting of acetone, methyl ethyl ketone, methyl alcohol, ethyl alcohol, isopropyl alcohol, butyl alcohol, ethylene glycol, polyethylene glycol, tetrahydrofuran, dimethylformamide, dimethylacetamide, N-methyl-2-pyrrolidone, hexane, cyclohexanone, toluene, chloroform, distilled water, dichlorobenzene, dimethylbenzene, trimethyl benzene, pyridine, methylnaphthalene, nitromethane, acrylonitrile, octadecylamine, aniline, dimethyl sulfoxide, methylene chloride, diethylene glycol methyl ethyl ether, and ethyl acetate may be used.

In addition, as the polymer, one or more types selected from the group consisting of polyvinylpyrrolidone (PVP), polyvinyl alcohol (PVA), polyethylene glycol (PEG), polypropylene glycol (PPG), and polyacrylic acid (PAA) may be used.

In this case, the solvent and polymer may stirred at a mixing ratio of 85:15 parts by weight, preferably 90:10 parts by weight, and more preferably 95:5 parts by weight, or at a mixing ratio of 15:3 parts by weight, preferably 10:2 parts by weight, and more preferably 5:1 parts by weight.

In the step (c) S130, a first graphene solution is prepared by adding the prepared graphene nanoplatelets to the prepared first polymer solution.

More specifically, the first graphene solution is prepared by adding the graphene nanoplatelets to the first polymer solution at a mixing ratio of 0.2 to 20 parts by weight, preferably 0.5 to 15 parts by weight, more preferably 1 to 10 parts by weight, based on 100 parts by weight of the first polymer solution.

Next, in the step (d) S140, the first graphene solution is homogenized at high speed to prepare a second graphene solution.

At this time, the first graphene solution is subjected to high-speed homogenization using a high-speed homogenizer, which performs high-speed homogenization at a speed of 4,000 rpm to 10,000 rpm for 30 to 60 minutes to obtain the second graphene solution.

More specifically, the graphene nanoplatelets contained in the first graphene solution undergo shear stress as they pass through nanocells of the high-speed homogenizer, causing the layers of graphite to delaminate, thereby obtaining the second graphene solution.

Then, in the step (e) S150, a coating ink composition containing graphene nanoplatelets is prepared by using the second graphene solution under shear stress of the high-pressure homogenizer.

At this time, the second graphene solution may be repeatedly high-pressure homogenized 3 to 10 times by applying shear stress for 30 to 60 minutes under pressure conditions of 1,000 bar to 2,000 bar through the high-pressure homogenizer to prepare a coating ink composition containing graphene nanoplatelets.

### Preparation Example 2

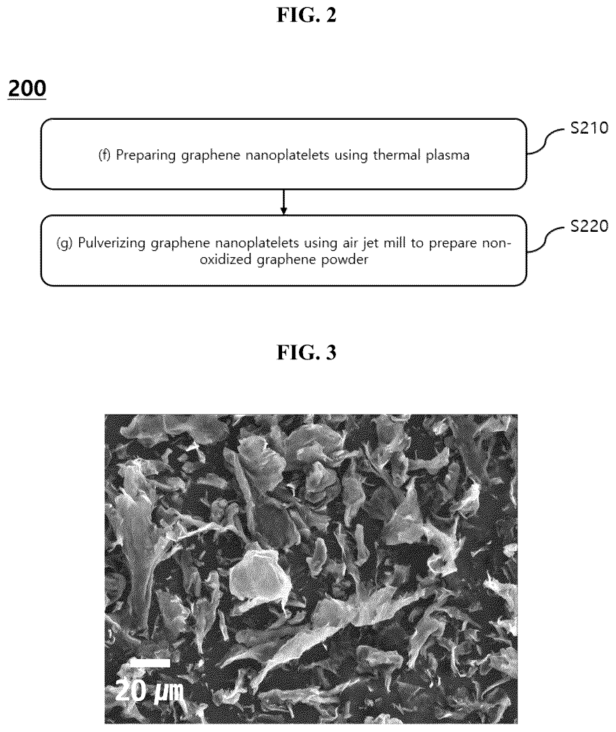

FIG. 2 is a flowchart illustrating a method 200 of preparing a coating ink composition using non-oxidized graphene powder according to one embodiment of the present disclosure.

Referring to FIG. 2, the method 200 may include: (f) preparing graphene nanoplatelets using thermal plasma (S210); and (g) pulverizing the graphene nanoplatelets using an air jet mill to prepare non-oxidized graphene powder (S220), in addition to the method 100.

More specifically, in the step S220, the prepared non-oxidized graphene powder is added to the first polymer solution prepared in the step (b) S120 to prepare a first graphene solution.

In this case, the first graphene solution is prepared by adding the non-oxidized graphene powder to the first polymer solution at a mixing ration of 0.05 to 20 parts by weight, preferably 0.08 to 14 parts by weight, more preferably 0.1 to 10 parts by weight, based on 100 parts by weight of the first polymer solution.

More specifically, an average particle size of the non-oxidized graphene powder is 0.2 μm to 20 μm and more preferably 1 μm to 10 μm.

Then, in the step S120, a first polymer solution is prepared by mixing and stirring the polymer in the solvent.

Here, as the solvent, a polar solvent, such as water, an alcohol solvent including ethanol, chloroform, glycerol, and acetic acid, may be used, and more specifically, one or more types selected from the group consisting of acetone, methyl ethyl ketone, methyl alcohol, ethyl alcohol, isopropyl alcohol, butyl alcohol, ethylene glycol, polyethylene glycol, tetrahydrofuran, dimethylformamide, dimethylacetamide, N-methyl-2-pyrrolidone, hexane, cyclohexanone, toluene, chloroform, distilled water, dichlorobenzene, dimethylbenzene, trimethyl benzene, pyridine, methylnaphthalene, nitromethane, acrylonitrile, octadecylamine, aniline, dimethyl sulfoxide, methylene chloride, diethylene glycol methyl ethyl ether, and ethyl acetate may be used.

In addition, as the polymer, one or more types selected from the group consisting of polyvinylpyrrolidone (PVP), polyvinyl alcohol (PVA), polyethylene glycol (PEG), polypropylene glycol (PPG), and polyacrylic acid (PAA) may be used.

In this case, the solvent and polymer may stirred at a mixing ratio of 85:15 parts by weight, preferably 90:10 parts by weight, and more preferably 95:5 parts by weight, or at a mixing ratio of 15:3 parts by weight, preferably 10:2 parts by weight, and more preferably 5:1 parts by weight.

In the step (c) S130, a first graphene solution is prepared by adding the prepared non-oxidized graphene powder to the prepared first polymer solution.

More specifically, the first graphene solution is prepared by adding the non-oxidized graphene powder to the first polymer solution at a mixing ration of 0.2 to 20 parts by weight, preferably 0.5 to 15 parts by weight, more preferably 1 to 10 parts by weight, based on 100 parts by weight of the first polymer solution.

Next, in the step (d) S140, the first graphene solution is homogenized at high speed to prepare a second graphene solution.

At this time, the first graphene solution is subjected to high-speed homogenization using a high-speed homogenizer, which performs high-speed homogenization at a speed of 4,000 rpm to 10,000 rpm for 30 to 60 minutes to obtain the second graphene solution.

More specifically, the non-oxidized graphene powder contained in the first graphene solution undergo shear stress as they pass through nanocells of the high-speed homogenizer, causing the layers of graphite to delaminate, thereby obtaining the second graphene solution.

Then, in the step (e) S150, a coating ink composition containing non-oxidized graphene powder is prepared by using the second graphene solution under shear stress of the high-pressure homogenizer.

At this time, the second graphene solution may be repeatedly high-pressure homogenized 3 to 10 times by applying shear stress for 30 to 60 minutes under pressure conditions of 1,000 bar to 2,000 bar through the high-pressure homogenizer to prepare a coating ink composition containing non-oxidized graphene powder.

### Preparation Example 3

A method (not shown) of coating a metal surface using the coating ink composition prepared by the method 100, 200 according to one embodiment of the present disclosure will be described.

The method 100, 200 includes a step of coating the coating ink composition on a metal surface (not shown), and a step of forming a graphene coating film on the metal surface by drying or heat-treating the coated coating ink (not shown).

More specifically, the step of coating the coating ink composition (not shown) may be performed by one type of coating method selected from dip-coating, doctor-blade coating, slot-die coating, and spray coating.

In this case, after coating the coating ink composition on the metal surface, a grapheme coating film may be prepared by drying at a temperature of 40° C. to 120° C. for 1 to 20 minutes, or by a heat treatment process at a temperature of 200° C. to 350° C. for 1 to 20 minutes.

In addition, the thickness of the graphene coating film coated on the metal surface may be easily adjusted by the coating method, coating conditions, and concentration of the coating ink composition.

The coating ink composition may be easily coated on various types of metal surfaces, such as copper (Cu), aluminum (Al), stainless steel (SUS), iron (Fe), nickel (Ni), zinc (Zn), titanium (Ti), lead (Pb), and the like, and may be prepared as a metal surface graphene coating film with a thickness ranging from tens of nanometers (nm) to several micrometers (μm).

Further, the coating ink composition may further include an organic additive, and the organic additive may include one or more selected from the group consisting of polyacylamide, poly(vinylidene fluoride), poly(vinylidene fluoride), poly(vinyl pyrrolidone), poly(methyl methacrylate), poly(vinyl acetate), poly(vinyl chloride), poly(vinyl alcohol), and poly(acrylic acid).

The organic additive can be easily coated on a metal surface by adding and mixing the organic additive to the coating ink composition to effectively improve mutual competition between graphene nanomembranes and adhesion between the graphene nanomembrane and the metal surface.

Hereinafter, the method 100, 200 of preparing a coating ink composition according to one embodiment of the present disclosure will be described through specific experimental examples and test examples. However, these examples are for illustrative purposes only and the scope of the present disclosure is not limited to these experimental examples and test examples.

### Experimental Example 1

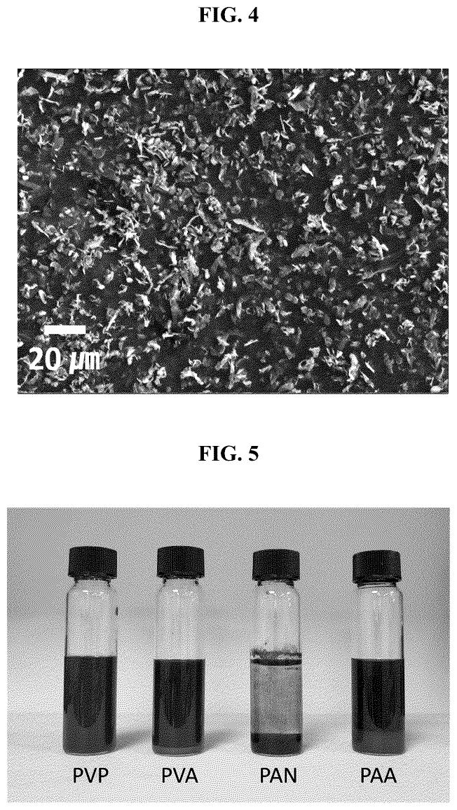

First, FIGS. 3 and 4 show SEM photographs of graphene nanoplatelets and non-oxidized graphene prepared through the method 100, 200 of preparing a coating ink composition according to one embodiment of the present disclosure.

Referring to FIGS. 3 and 4, it can be seen that expandable graphite (EG) is rapidly expanded by thermal plasma treatment, resulting in a rapid increase in the interlayer distance to obtain graphene nanoplatelets and non-oxidized graphene powder.

TABLE 1

| | Raw Material | | |
|---|---|---|---|
| | Concentration | | Polymer concentration |
| Raw Material | (Parts by weight) | Polymer type | (part by weight) |
| Non-oxide | 2 | PVP | 2 |
| graphene | | PVA | |
| | | PVN | |
| | | PAA | |

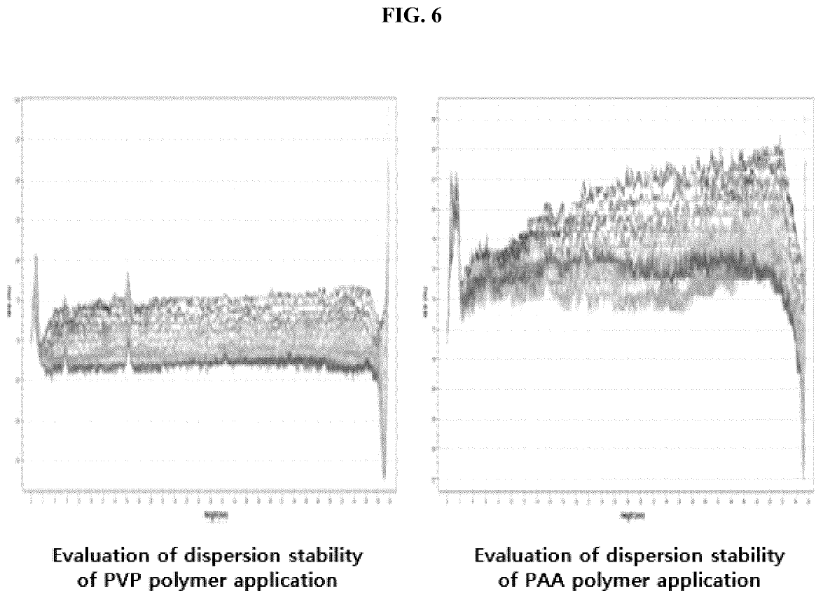

FIG. 6 is a graph the results of measuring the ink composition prepared by the method 100 of preparing a coating ink composition according to one embodiment of the present disclosure using Turviscan.

Referring to Table 1, and FIGS. 3 and 6, in order to select an appropriate polymer that can be used in the method 100 of preparing a coating ink composition according to the present disclosure, based on 2 parts by weight of non-oxidized graphene, 2 parts by weight of polyvinylpyrrolidone (PVP), 2 parts by weight of polyvinyl alcohol (PVA), 2 parts by weight of polyacrylonitrile (PAN), and 2 parts by weight of polyacrylic acid (PAA) were respectively added, and it was confirmed that polyvinylpyrrolidone (PVP) exhibited the best dispersion stability through Turbiscan.

Furthermore, it was confirmed that precipitation occurred rapidly in the cases of the remaining polymers except for the ink composition containing polyvinylpyrrolidone (PVP).

TABLE 2

| | | Raw Material | | Polymer |
|---|---|---|---|---|
| Preparation | Raw | Concentration | Polymer | concentration |
| Example | Material | (Parts by weight) | type | (part by weight) |
| Test | Graphene | 2 | PVP | 10 |
| Example 1 | Nanoplatelets | | | |
| Comparative | (40 μm) | | | 8 |
| Example 1 | | | | |
| Comparative | | | | 6 |
| Example 2 | | | | |
| Comparative | | | | 4 |
| Example 3 | | | | |
| Test | Non- | 2 | PVP | 10 |
| Example 2 | oxidized | | | |
| Comparative | graphene | | | 8 |
| Example 4 | (6 μm) | | | |
| Comparative | | | | 6 |
| Example 5 | | | | |
| Comparative | | | | 4 |
| Example 6 | | | | |

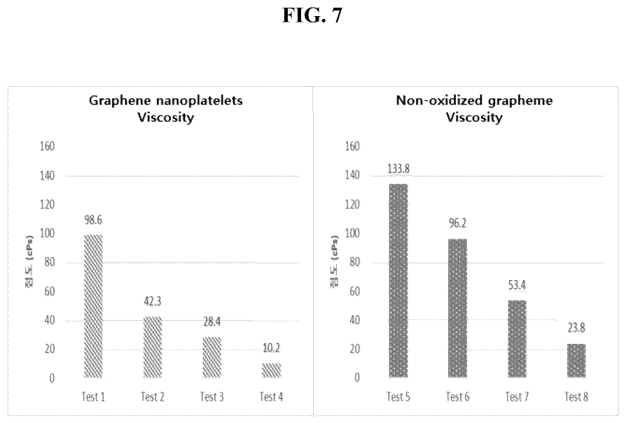

FIG. 7 is a graph showing the results of comparing the viscosity of ink compositions prepared by the coating ink composition preparation method 100, 200 according to one embodiment of the present disclosure using a Brookfield viscometer.

Referring to Table 2 and FIG. 7, as shown in Test Example 1, Test Example 2, and Comparative Examples 1 to 6, the synthesis was performed by adjusting the weight ratio of polyvinylpyrrolidone (PVP) based on 2 parts by weight of graphene nanoplatelets and non-oxidized graphene, respectively.

TABLE 3

| Test | Raw Material | Viscosity |
|---|---|---|
| Test Example 1 | Graphene Nanoplatelets | 98.6 |
| Comparative Example 1 | (40 μm) | 42.3 |
| Comparative Example 2 | | 28.4 |
| Comparative Example 3 | | 10.2 |
| Test Example 2 | Non-oxidized graphene | 133.8 |
| Comparative Example 4 | (6 μm) | 96.2 |
| Comparative Example 5 | | 53.4 |
| Comparative Example 6 | | 23.8 |

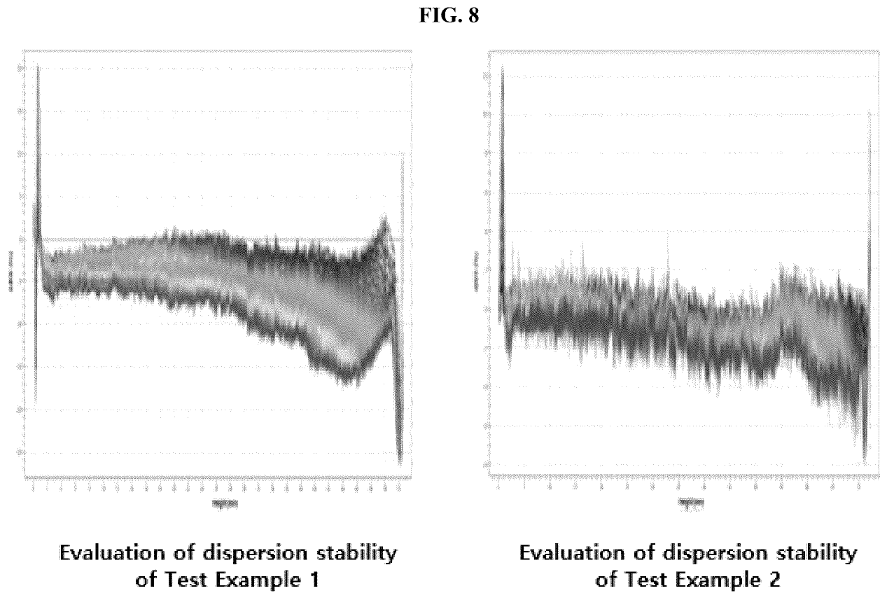

FIG. 8 is a graph showing the results of measuring the ink composition prepared by the coating ink composition preparation method 100, 200 according to one embodiment of the present disclosure through Turviscan.

Referring to Table 3 and FIG. 8, in Test Example 1, when 2 parts by weight of graphene nanoplatelets and 10 parts by weight of polyvinylpyrrolidone (PVP) were mixed, the viscosity was 98.6, and in Test Example 2, when 2 parts by weight of non-oxidized graphene and 10 parts by weight of polyvinylpyrrolidone (PVP) were mixed, the viscosity was 133.8.

Hereinafter, the characteristics of the coating ink composition according to one embodiment of the present disclosure will be described.

### Experimental Example 2

An anode for a secondary battery was prepared by coating the coating ink composition according to Test Examples 1 and 2 of the present disclosure, and Comparative Examples 1 to 6 on a copper metal surface, and then applying active material slurry mixed with LiFePO₄, LiCoO₂, and LiNiO₂ on the coating.

Here, the interfacial resistance and adhesion between the coating ink composition and the slurry layer were measured and shown in Table 4 below.

TABLE 4

| | Test | Test | Comparitive | Comparitive | Comparitive | Comparitive | Comparitive | Comparitive |
|---|---|---|---|---|---|---|---|---|
| Item | Example 1 | Example 2 | Example 1 | Example 2 | Example 3 | Example 4 | Example 5 | Example 6 |
| Interfacial | 1.16 | 1.13 | 3.21 | 3.62 | 4.11 | 4.28 | 5.14 | 5.32 |
| Resistance | | | | | | | | |
| (Ω/cm²) | | | | | | | | |
| Adhesion | 72.1 | 71.5 | 15.3 | 15.5 | 16.2 | 16.4 | 17.6 | 17.9 |
| (gf/25 mm) | | | | | | | | |

More specifically, referring to Table 4 above, in the case of an electrode for a secondary battery manufactured by applying the coating ink composition according to the test example, it was confirmed that the interfacial resistance and the adhesion between the current collector and the slurry layer containing the active material was excellent in Test Examples 1 and 2.

### Experimental Example 3

The effectiveness of membranes for secondary battery prepared in Test Examples 1 and 2, and Comparative Examples 1 to 6 was measured by the following method, and the results are shown in Table 5 below.

TABLE 5

| | Test | Test | Comparitive | Comparitive | Comparitive | Comparitive | Comparitive | Comparitive |
|---|---|---|---|---|---|---|---|---|
| Item | Example 1 | Example 2 | Example 1 | Example 2 | Example 3 | Example 4 | Example 5 | Example 6 |
| Electrolyte | 61 | 63 | 54 | 58 | 47 | 43 | 38 | 34 |
| Moisture | | | | | | | | |
| (%) | | | | | | | | |
| Ionic | 0.51 | 0.53 | 0.57 | 0.45 | 0.27 | 0.23 | 0.18 | 0.14 |
| Conductivity | | | | | | | | |
| (mS/cm) | | | | | | | | |
| Pore | ~110 | ~110 | ~140 | ~138 | ~120 | ~105 | ~130 | ~110 |
| blockage | | | | | | | | |
| (° C.) | | | | | | | | |
| Thickness | −2 | −4 | −6 | −7 | −13 | −12 | −16 | −14 |
| Reduction | | | | | | | | |
| (μm) | | | | | | | | |
| Shrinkage | 4 | 2 | 15 | 24 | 22 | 19 | 25 | 23 |
| rate | | | | | | | | |
| (%) | | | | | | | | |

### 1. Electrolyte Moisture

A membrane having predetermined dimensions was impregnated with an electrolyte solution containing lithium salt and then taken out, and the weight gain ratio of the membrane was measured.

### 2. Ionic Conductivity

A membrane having predetermined dimensions was impregnated with an electrolyte solution containing lithium salt and bonded between two stainless steel (SUS) electrodes, and then ionic conductivity was measured.

### 3. Pore Blockage

A membrane having predetermined dimensions was impregnated with an electrolyte solution containing lithium salt, and then the electrical resistance was measured as a function of according to temperature (Hot ER test) to confirm the temperature at which the resistance rapidly increases.

### 4. Thickness Reduction and Shrinkage Rate

A membrane having a predetermined dimension was left in an oven at 150° C. for 10 minutes, and then the shrinkage rate was calculated by measuring the thickness and the change in area of the membrane.

Referring to Table 5 above, pore blockage occurs in the membrane for secondary batteries at around 140° C., and in Comparative Examples 1 and 2, it was confirmed that pore blockage occurred too late, that is, there was no effect of suppressing thermal runaway.

In Comparative Examples 3 to 6, it was confirmed that the change in thickness reduction and shrinkage rate was very large, which causes an internal short circuit of the battery due to thermal contraction, resulting in thermal runaway.

On the other hand, in the case of Test Examples 1 and 2 according to one embodiment of the present disclosure, it was confirmed that thermal contraction does not occur, so no internal short circuit of the battery occurs at high temperatures, thereby preventing thermal runaway occurring inside the secondary battery.

As can be seen in the above Preparation Examples, Experimental Examples, Test Examples and Comparative Examples, when an ink composition is prepared using the preparation method of the present disclosure, an ink composition having a high viscosity and excellent dispersion stability can be prepared.

The description of the present disclosure described above is for illustrative purposes, and those of ordinary skill in the art will understand that the present disclosure can be easily modified into other specific forms without changing technical idea or essential features of the present disclosure.

Therefore, the embodiments described above should be understood in all respects as illustrative and not restrictive. For example, each component described as single may be implemented in a distributed manner, and similarly, components described as distributed may also be implemented in a combined form.

The scope of the present disclosure is defined by the following claims rather than the detailed description above, and all changes or modifications derived from the meaning and scope of the claims and their equivalent concepts should be construed as being included in the scope of the present disclosure.

### DESCRIPTION OF REFERENCE NUMERALS

100: Method of preparing a coating ink composition containing graphene nanoplatelets
S110: Preparing graphene nanoplatelets using thermal plasma
S120: Mixing and stirring a polymer in a solvent to prepare a first polymer solution
S130: Adding the prepared graphene nanoplatelets to the prepared first polymer solution to prepare a first graphene solution
S140: Homogenizing the first graphene solution at high speed to prepare a second graphene solution
S150: Preparing a coating ink composition containing graphene nanoplatelets using the second graphene solution under shear stress in a high-pressure homogenizer
200: Method of preparing a coating ink composition containing non-oxidized graphene powder
S210: Preparing graphene nanoplatelets using thermal plasma
S220: Pulverizing the graphene nanoplatelets using an air jet mill to prepare non-oxidized graphene powder

1. A method of preparing a coating ink composition, the method comprising the steps of:
(a) preparing graphene nanoplatelets using thermal plasma;
(b) mixing and stirring a polymer in a solvent to prepare a first polymer solution;
(c) adding the prepared graphene nanoplatelets to the prepared first polymer solution to prepare a first graphene solution;
(d) homogenizing the first graphene solution at high speed to prepare a second graphene solution; and
(e) preparing a coating ink composition containing graphene nanoplatelets using the second graphene solution under shear stress in a high-pressure homogenizer.

2. The method of claim 1, wherein an average particle size of the graphene nanoplatelets is 0.1 μm to 100 μm.

3. The method of claim 1, wherein the solvent is at least one selected from the group consisting of water, alcohol solvents including ethanol, chloroform, glycerol, and acetic acid.

4. The method of claim 1, wherein the polymer is at least one selected from the group consisting of polyvinylpyrrolidone (PVP), polyvinyl alcohol (PVA), polyethylene glycol (PEG), polypropylene glycol (PPG), polyacrylo nitrile (PAN), and polyacrylic acid (PAA).

5. The method of claim 1, wherein the first polymer solution is a mixture of the solvent and the polymer at a mixing ratio of 95:5 or 5:1.

6. The method of claim 1, wherein the graphene nanoplatelets added to the first polymer solution in the step (c) are added at a mixing ratio of 0.2 to 20 parts by weight based on 100 parts by weight of the first polymer solution.

7. The method of claim 1, further comprising:
(f) preparing graphene nanoplatelets using thermal plasma; and
(g) pulverizing the graphene nanoplatelets using an air jet mill to prepare non-oxidized graphene powder.

8. The method of claim 7, wherein an average particle size of the non-oxidized graphene powder is 0.2 μm to 20 μm.

9. A coating ink prepared by the method of preparing a coating ink composition according to claim 1.

10. A method of coating a metal surface, the method comprising:
coating the coating ink according to claim 9 on a metal surface; and
forming a graphene coating film on the metal surface by drying or heat-treating the coated coating ink.

11. The method of claim 10, wherein the coating of the coating ink is performed by one selected from dip-coating, doctor-blade coating, slot-die coating, and spray coating.

12. The method of claim 10, wherein in the forming of the graphene coating film, the graphene coating film is dried at a temperature of 30° C. to 100° C. for 5 to 30 minutes, or heat-treated at a temperature of 100° C. to 200° C. for 10 to 120 minutes.

13. A graphene-coated metal material comprising:
a metal material; and
a graphene coating film coated on a surface of the metal material by the method of coating a metal surface according to claim 10.

14. A lithium secondary battery comprising:
an electrode having a surface of a current collector coated with the coating ink according to claim 9.

15. The lithium secondary battery of claim 14, wherein the coated electrode is an anode and/or a cathode.

16. The lithium secondary battery of claim 14, wherein the lithium secondary battery is a lithium secondary battery for thermal runaway delay.
